(19) United States
(12) Patent Application Publication
(10) Pub. No.: US 2005/0099908 A1
(43) Pub. Date: May 12, 2005

(54) Playback apparatus and method, and optical disk player

(75) Inventors: Goro Fujita, Kanagawa (JP); Kazuhiko Fujiie, Kanagawa (JP); Yasuhito Tanaka, Tokyo (JP); Kimihiro Saito, Saitama (JP); Tetsuhiro Sakamoto, Tokyo (JP); Takeshi Miki, Tokyo (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/950,385

(22) Filed: Sep. 28, 2004

(30) Foreign Application Priority Data
Oct. 15, 2003 (JP) 2003-355368

(51) Int. Cl. G11B 5/09

(52) U.S. Cl. 369/47.27; 369/124.01

(57) ABSTRACT

The present invention provides an optical disk drive and optical disk playback method, with an improved capability of reading address information from an optical disk having address information recorded thereon by wobbling one of side walls of a recording track, with a wider tilt margin.

### BACKGROUND OF THE INVENTION

1. Field of the Invention

The present invention relates to a playback apparatus and method and an optical disk player, capable of reading address information intended for indication and management of data addresses from a disk-shaped recording medium having the address information recorded therein by wobbling side walls of a recording-track groove.

This application claims the priority of the Japanese Patent Application No. 2003-355368 filed on Oct. 15, 2003, the entirety of which is incorporated by reference herein.

2. Description of the Related Art

It has already been proposed to record information on synchronization of optical disk rotation, address information intended for indication of data addresses, etc. as a wobble of a recording track groove. For example, CD-R (compact disk-recordable), MD (Mini Disc, a Sony's trade name), etc. have preformed therein a recording track groove having a wobble to which, for example, frequency-modulated (FM) address information is imparted. FIG. 1 explains an example of a wobbled groove. As shown in FIG. 1, the groove as a recording track, indicated with a reference G, is formed for its opposite side walls to wobble radially of the disk correspondingly to the FM address information or the like. Recording of the address information as such a wobble is advantageous in the respect of redundancy elimination because addressing can be made with address information being superposed on the recording track but without having to form any special area for pit addresses.

Also, there has recently been developed a technique of recording address information or the like to both the land and groove for an improved density of the recording track. In this case, when address information or the like is recorded by wobbling both the side walls of the groove G as shown in FIG. 1, address information along the adjacent grooves G will be detected as a mixture with each other when the land L is traced. On this account, it is well known as disclosed in the Japanese Patent Application Laid Open No. H05-314538, for example, that to apply wobble addresses for recording the address information to both the lands and grooves, an FM wobble signal is recorded to one side wall of a groove to wobble only the one side wall to hold one piece of address information by the boundary between each groove and a groove adjacent to that groove.

FIG. 2 shows an example of the above recording of address information or the like, in which only one side wall of the groove G (or land L) of the recording track is wobbled.

Generally, wobble address information is detected by supplying a bandpass filter with a push-pull signal which is a differential output from a bi-block photodetector used as a tracking error signal and extracting FM address information signals of a higher frequency, used in tracking servo control, by the bandpass filter. This wobble address information detection is also used in recording address information or the like by wobbling the one side wall of the groove as above.

When a laser beam is projected obliquely to an optical disk, namely, when a so-called “tilt” takes place, especially when a radial tilt directed radially of the optical disk takes place, the wobble will be positioned at one side of a reading spot so that the beam profile will be influenced by a coma aberration to be skewed radially of the disk as shown in FIG. 3 depending upon the direction of the radial tilt, and thus no wobble signal can positively be detected.

As shown in FIG. 3, a piece of address information is recorded as a wobble W of only one side wall of each groove G (or land L). FIG. 3 shows beam profiles when a curve a is inclined at an angle of 0 deg., a curve b is inclined at an angle of 0.6 deg. and a curve c is inclined at an angle of 1.2 deg., respectively, on the assumption that the laser beam is inclined clockwise at a positive (+) angle.

FIG. 4 graphically illustrates results of measurements of a radial tilt margin of a jitter when a signal such as address information or the like recorded as a wobble, called “wobble signal”, is read from the land L and groove G. In FIG. 4, a curve a indicates an ECC error of the wobble signal when a groove is traced, and a curve b indicates an ECC error of the wobble signal when a land is traced. Also, in FIG. 4, a reference tmG indicates a tilt margin of the groove, and a reference tmL indicates a tilt margin of the land. It should be noted that the value of ECC error indicates the number of ones of 8192 sectors in each of which the ECC error has occurred.

As apparent from FIG. 4, when a tilt take place in an optical disk, a reading error is likely to asymmetrically take place in a tilting direction at the land or groove.

The above margin depends upon a beam skew-caused reduction of wobble amplitude and crosstalk from the land or groove. To provide a signal reading system whose margin is wider, it is necessary to use a detecting method less influenced by the wobble amplitude reduction and crosstalk.

### OBJECT AND SUMMARY OF THE INVENTION

The present invention has an object to provide a reproducing apparatus for reproducing a disk-shaped recording medium in which management data different from to-be-recorded data has been recorded by wobbling one of two side walls of a recording track on which the data is to be recorded, the apparatus including according to the present invention:
a driving means for rotating the recording medium at a predetermined velocity,
a light signal irradiating means for irradiating, to the recording medium, a light signal for reading data from the recording medium being rotated by the driving means;
a light detecting means including a photodetector divided in acceptance areas extending along the recording track on the recording medium, each of which detects a part, returned from the recording medium, of the light signal irradiated from the light signal irradiating means; and
a management data reproducing means for reproducing the management data recorded on the side wall of the recording track from a signal output supplied from one of the acceptance areas and derived from the return light detected by the light detecting means.

Also the present invention has another object to provide a reproducing method of reproducing management data different from to-be-recorded data by rotating a disk-shaped recording medium in which the management data has been recorded by wobbling one of two side walls of a recording track on which the data is to be recorded, the method including, according to the present invention, the steps of:
irradiating, to the recording medium, a light signal for reading data from the recording medium;
detecting a return light from the recording medium by a light detecting means including a photodetector divided in acceptance areas extending along the recording track on the recording medium, each of which detects a part, returned from the recording medium, of the light signal irradiated in the light signal irradiating step; and
reproducing the management data recorded on the side wall of the recording track from a signal output supplied from one of the acceptance areas and derived from the return light detected by the light detecting means.

Also the present invention has still another object to provide an optical disk reproducing apparatus for reproducing digital data by rotating an optical disk in which signal information distinguishable from to-be-recorded data has recorded by wobbling one of two side walls of a recording track on which the signal information is to be recorded, irradiating a laser beam to the optical disk and detecting a return light from the latter, wherein:
a light detection signal from one of two acceptance areas formed by bisecting, longitudinally of the recording track, a photodetector that detects a part, returned from the optical disk, of the laser beam irradiated to the latter, is used to detect a signal recorded by wobbling the one side wall of the recording track.

These objects and other objects, features and advantages of the present invention will become more apparent from the following detailed description of the preferred embodiments of the present invention when taken in conjunction with the accompanying drawings.

### BRIEF DESCRIPTION OF THE DRAWINGS

FIG. 1 is a plan view, partially enlarged in scale, of a typical example of an optical disk having address information recorded therein by wobbling both side walls of a groove G;

FIG. 2 is also a plan view, partially enlarged in scale, of a typical example of an optical disk having address information recorded therein by wobbling one of side walls of the groove G;

FIG. 3 shows beam profiles of a laser beam, defined on the optical disk when a radial tilt takes place;

FIG. 4 graphically illustrates the result of measurement of a radial tilt margin of a jitter when a signal such as address information or the like recorded by wobbling is reproduced;

FIG. 5 schematically illustrates the construction of the optical disk player according to an embodiment of the present invention, for explaining the theory of operation of the apparatus;

FIG. 6 is a plan view of an example of two acceptance areas formed by bisecting a photodetector;

FIG. 7 is a plan view of an example of acceptance areas formed by quartering a photodetector;

FIG. 8 schematically illustrates the construction of the optical disk player, for explaining an example of a differential push-pull detection in case both side walls of a groove are wobbled to record address information;

FIG. 9 graphically illustrates the results of calculation of a wobble component signal and crosstalk component for a one-side detection and differential detection made in case there is played an optical disk in which one side wall of a groove is wobbled;

FIG. 10 graphically illustrates the results of measurement of C/N (carrier/noise) ratio and crosstalk, made based on a reading signal actually provided from an optical disk recorder/player;

FIG. 11 graphically illustrates the results of measurement of C (carrier) and N (noise) components, made based on the reading signal provided from the optical disk recorder/player;

FIG. 12 is a schematic block diagram of the optical disk recorder/player used in the embodiment of the present invention; and

FIG. 13 shows a tilt margin based on the amount of error taking place when address information is reproduced from wobble signal component.

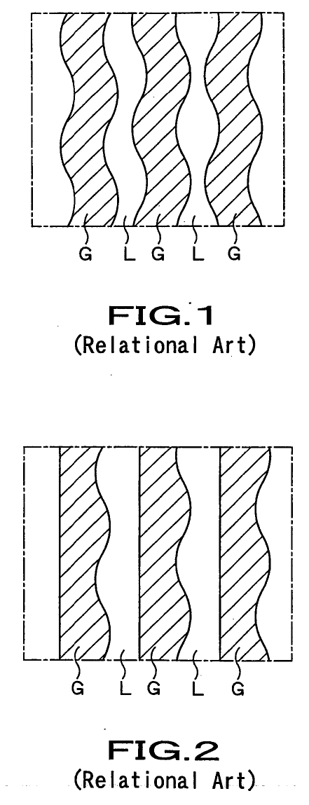

### DETAILED DESCRIPTION OF THE PREFERRED EMBODIMENTS

The present invention will be described in detail concerning embodiments thereof in which the optical disk playback method and apparatus according to the present invention are applied with reference to the accompanying drawings.

FIG. 5 schematically explains the theory of operation of the embodiment of the present invention.

As shown in FIG. 5, the optical disk has a data recording track using both grooves G and lands L. One of the side walls of the recording track is wobbled (as indicated with a reference W) radially of the optical disk according to frequency-modulated (FM) address information. As shown, a photodetector 20 is bisected into two acceptance areas 21 and 22 longitudinally of the recording track. The address information is detected based on an output signal supplied from only one (the acceptance area 22, for example) of the two acceptance areas 21 and 22 and of which the wobble signal component shares a large part when the groove G or land L of the recording track is traced.

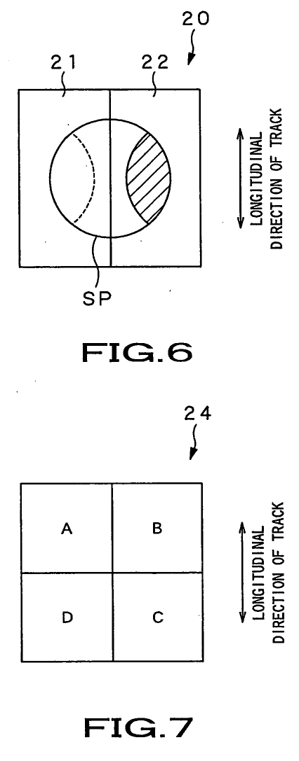

FIG. 6 is a plan view of an example of the photodetector 20 formed from two acceptance areas 21 and 22 defined by bisecting the photodetector 20 longitudinally of the recording track. Each of these acceptance areas 21 and 22 may be formed from a pair of two of four acceptance areas A, B, C and D as in a quartered photodetector 24 shown in FIG. 7. For example, the acceptance area 21 may be formed from a pair of acceptance areas A and D, while the acceptance area 22 may be formed from a pair of acceptance areas B and C.

In the case of an optical disk in which only one of the side walls of the groove G or land L of the recording track as in the embodiment of the present invention is wobbled (as indicated with the reference W), there can effectively be detected only the wobble corresponding to one (the acceptance area 22, for example) of the two acceptance areas 21 and 22 of the photodetector 20, defined by bisecting the latter longitudinally of the recording track, as the case may be. In such a condition is found, a differentiation is made between signal outputs from the acceptance areas 21 and 22, respectively, with a result that the amplitude will not be doubled but the wobble noise will be doubled, so that the C/N (carrier/noise) ratio will not always be effective. In this case, use of only the output from the acceptance area corresponding to the wobbled side wall will permit to prevent the noise from increasing.

Also, in case the wobble signal component shares a large part of a light detection signal from one (22) of the two acceptance areas 21 and 22 when the groove G of the recording track is traced while the wobble signal component shares a large part of a light detection signal from the other acceptance area (21) when the land L of the recording track is traced, either of light detection signals from the two acceptance areas 21 and 22 of the photodetector 20 should selectively be used depending upon whether the groove G or land L is to be traced.

In short, for addressing data recorded in an optical recording medium, the embodiment of the present invention uses a wobble signal detected from an optical recording medium having a land and groove formed as a recording track thereon, more particularly, from one of two acceptance areas of a bisected photodetector, which is corresponding to a groove side wall wobbled based on disk information such as rotation sync information, address information, etc.

Note that when the land L, for example, of the recording track is traced, the wobble signal component shares a large part of a signal indicative of a difference between light detection signals from the two acceptance areas 21 and 22 as the case may be depending upon conditions such as groove depth and the like. In this case, either of the light detection signals from the acceptance areas 21 and 22 may selectively be used in such a manner only a light detection signal from the acceptance area 21 is used when the groove G is traced while a signal of the difference-between the light detection signals from the acceptance areas 21 and 22 is used when the land L is traced.

In the example shown in FIG. 5, the groove depth is ⅛ of the wavelength of the irradiated light, namely, λ/8 when a laser beam of λ in wavelength is used. In case the groove depth is 3λ/8, the wobble signal component will take a large part of the light detection signal from one (21) of the two acceptance areas 21 and 22 of the bisected photodetector 20. In this case, either of the light detection signals from the acceptance areas 21 and 22 should selectively be used depending upon the groove depth of an optical disk used.

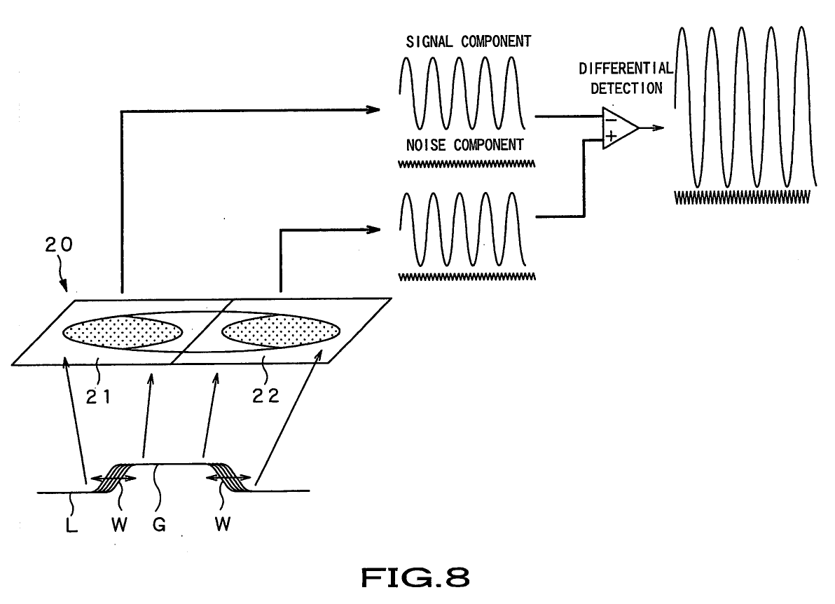

FIG. 8 illustrates an example of a differential push-pull detection in case both side walls of a groove G are wobbled (as indicated with a reference W) as in the conventional optical disks. As shown in FIG. 8, phase changes corresponding to modulations in disk-radial position of both the side walls of the groove G will appear as light and shade, respectively, on a portion in pupil where the zero-order diffracted light and primary diffracted light overlap each other in the two acceptance areas 21 and 22 of the bisected photodetector 20. Signal outputs from the acceptance areas 21 and 22 have phases different by 180 deg. from each other. They are differentiated between them to have a double amplitude. It should be noted that the differentiation will cause a noise having a wobble component generated by fluctuation or the like of a cutting beam to have the amplitude thereof doubled but noise components having the same phase will cancel each other and thus the noise component will have a double wobble amplitude so that the C/N (carrier/noise) ratio will relatively be improved.

In an optical disk in which one of the side walls of the groove G is wobbled (as indicated with a reference W), however, since only the wobble detected by the acceptance area 22 is effective in case the groove depth is N/8, for example, so that the differentiation will not lead to any double amplitude but the wobble noise will be doubled, the C/N (carried/noise) ratio is not always effective. On this account, in the embodiment of the present invention, only the signal output from one (22) of the two acceptance areas 21 and 22 is used to detect a wobble signal component.

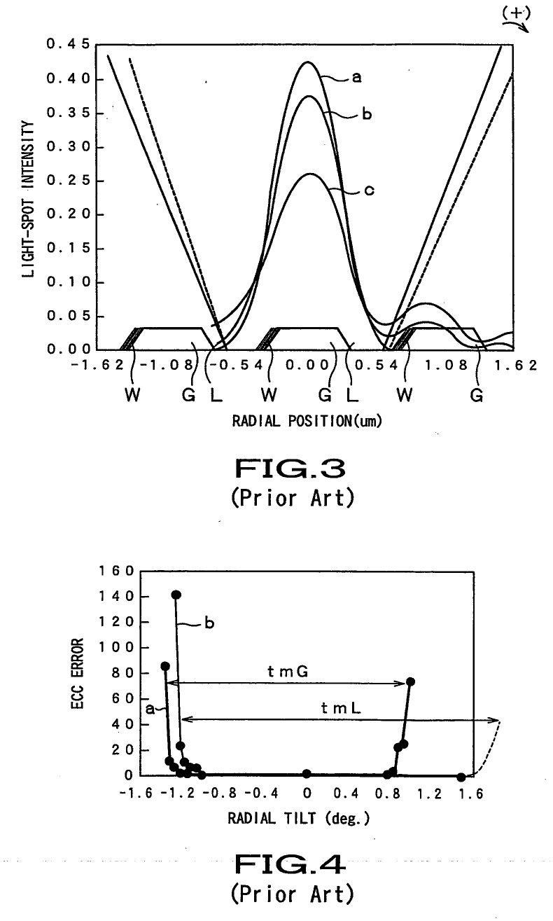

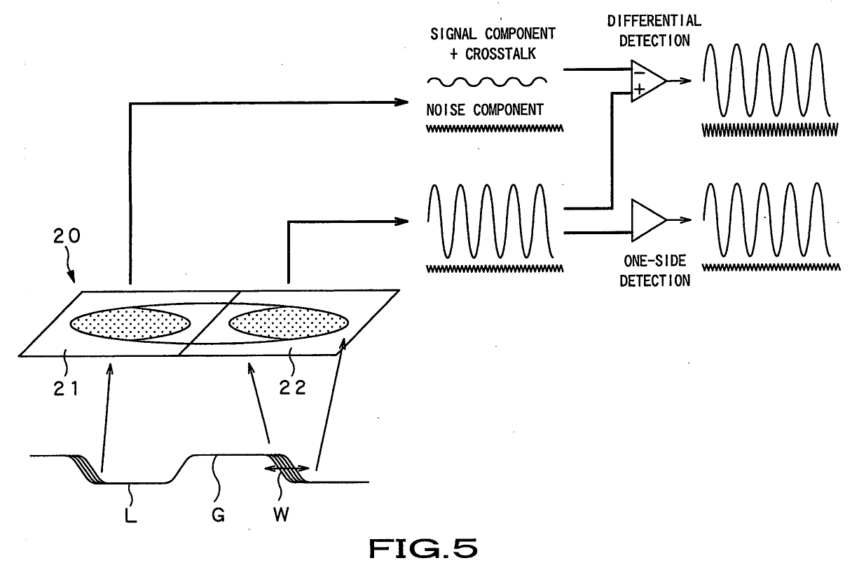

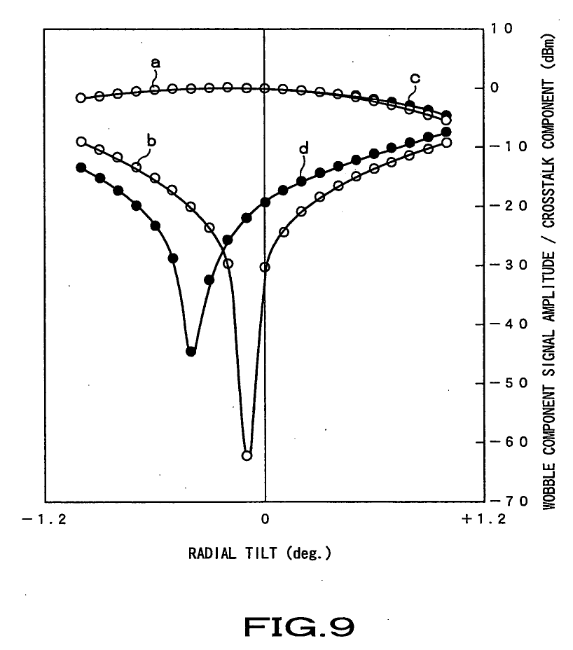

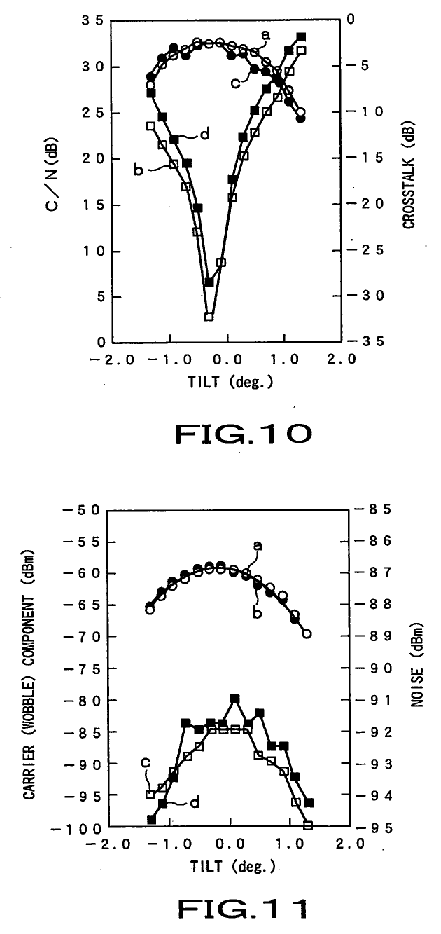

FIG. 9 graphically illustrates the results of calculation of a wobble component signal amplitude and crosstalk component for a one-side detection and a differential detection called “differential push-pull detection”, made in case there is played an optical disk in which one side wall of a groove is wobbled. In the one-side detection, a light detection signal from one of the two acceptance areas of the photodetector is used. In FIG. 9, the vertical axis represents the amplitude while the horizontal axis represents the radial tilt angle of a light beam in relation to a direction perpendicular to the optical disk surface. It should be noted that for the positiveness or negativeness (+/−) of a tilt angle, the angle of clockwise tilt of the light beam is taken as positive (+) as shown in FIG. 3. In FIG. 9, curves a and b indicate a wobble amplitude and crosstalk component, respectively, for the one-side detection, and curves c and d indicate a crosstalk component for the one-side detection and a wobble amplitude for the differential detection, respectively. Also, in the optical system of an optical disk recorder/player, the numerical aperture (NA) is 0.60 and light beam wavelength is 660 nm. In the optical disk, the substrate thickness t is 0.6 mm and groove pitch 1.08 μm. Namely, FIG. 9 shows the results of calculation made in case a wobble signal of ±20 nm is detected by the one-side detection and differential detection under conditions of 0.54 μm in pitch of a recording track formed from lands and grooves and ⅛ of the light beam wavelength in optical groove depth.

As apparent from FIG. 9, when the light beam is tilted at a positive angle with which an error is likely to take place, the wobble signal detected by the one-side detection is slightly smaller in amplitude but less in crosstalk than that detected by the differential detection. That is, the aforementioned one-side detection in the embodiment of the present invention is more capable of detecting a C/N and crosstalk than the conventional differential detection, especially when the groove noise is high.

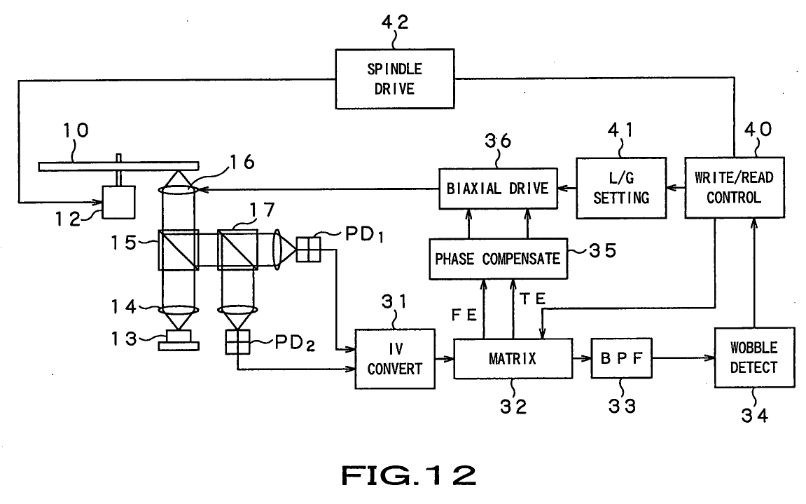

FIGS. 10 and 11 graphically illustrate the results of measurements of C/N (carrier/noise) ratio and crosstalk measured and C (carrier), and the results of measurement of N (noise) components, respectively, made based on a reading signal actually provided from an optical disk recorder/player. In the optical system of the optical disk recorder/player, the numerical aperture (NA) is 0.60 and light beam wavelength is 660 nm. In the optical disk, the substrate thickness t is 0.6 mm and groove pitch is 1.08 μm. Namely, FIGS. 10 and 11 show the values measured in case a wobble signal of ±20 nm is detected by the one-side detection and differential detection under conditions of 0.54 μm in pitch of a recording track formed from lands and grooves and ⅛ of the light beam wavelength in optical groove depth. The optical disk recorder/player may be a one which will be described later with reference to FIG. 12, for example.

In FIG. 10, curves a and b indicate a C/N (carrier/noise) ratio and crosstalk component, respectively, for the one-side detection, and curves c and d indicate C/N ratio for the one-side detection and a crosstalk component for the differential detection, respectively. In FIG. 11, curves a and b indicate a C (carrier) component and noise component, respectively, for the one-side detection, and curves c and d indicate a C component for the one-side detection and a noise component for the differential detection, respectively.

As also apparent from the results of measurement shown in FIGS. 10 and 11, when the light beam is tilted at a positive angle with which an error is likely to take place, the light detection signal is smaller in crosstalk when detected by the one-side detection than when detected by the differential detection as will be expected from the results of calculation shown in FIG. 9. Also, the light detection signal is higher in C/N ratio when detected by the one-side detection because of a lower noise as will be seen from FIG. 11. For example, when the light beam is tilted at a positive angle of 0.8 deg., the C/N ratio is 1 dB lower and crosstalk is 2 dB lower.

FIG. 12 is a schematic block diagram of the optical disk recorder/player used in the embodiment of the present invention. As shown in FIG. 12, an optical disk 10 as an optical recording medium is rotated by a spindle motor 12 at a desired velocity. A laser beam emitted from a light source 13 as a laser diode (LD) or the like is formed by a condenser lens 14 into a parallel beam. The parallel beam is passed through a beam splitter 15 to an objective lens 16 which will focus it on the optical disk 10 (recording medium). A return light from the optical disk 10 is passed through the objective lens 16 for incidence upon the beam splitter 15 which will direct it to a PBS (polarizing beam splitter) 17 by which it will be split toward photodetectors PD1 and PD2 for the purpose of detecting the magneto-optical Kerr effect. For example, each of the photodetectors PD1 and PD2 has its light-incident surface divided in four acceptance areas A, B, C and D as shown in FIG. 7. A current derived from light incident upon each of these acceptance areas A to D is sent to an IV (current-voltage) converter 31 where it will be converted to a voltage to provide a light detection output. Light detection outputs, once IV-converted, from these acceptance areas A to D are sent to a matrix circuit 32 where they will undergo a matrix calculation to provide error signals. That is, a focus error signal FE is provided through a calculation A+C−(B+D), and a tracking error signal TE is provided through a calculation B+C−(A+D). It should be noted that the conventional wobble address information is obtained by extracting, by a bandpass filter, a higher-frequency FM (frequency-modulated) address information signal component, for use in tracking servo control, of a differential push-pull signal as the tracking error signal. In the embodiment of the present invention, however, wobble address information is obtained based on a signal from one of the two acceptance areas of the photodetector bisected longitudinally of the recording track, or based on signals from the acceptance areas B+C or A+D, for example, of the quartered photodetector, as having been described above with reference to FIGS. 6 and 7.

Explanation will be made with reference to FIG. 12 again. A frequency component of a higher-frequency FM (frequency-modulated) address information signal component, for use in tracking servo control, is extracted by a bandpass filter (BPF) 33 from a calculation signal output B+C from the matrix circuit 32, for example, intended for detection of the wobble address information, and sent to a wobble detection circuit 34 where it will be FM-demodulated to provided address information, and this address information is sent to a write/read controller 40. Also, the focus error signal FE and tracking error signal TE from the matrix circuit 32 are sent to a biaxial drive circuit 36 via a phase compensation circuit 35. The write/read controller 40 controls an L/G setting circuit 41 to change the mode of operation of the biaxial drive circuit 36 according to whether the recording track to which data is to be written or from which data is to be read is a groove G or land L, to thereby select either a positive or negative polarity for the tracking control. Also, the write/read controller 40 sends an L/G selection control signal to the matrix circuit 32 as well to select a signal from either of the two acceptance areas for use for tracing the groove or land. Further, the write/read controller 40 controls the spindle drive circuit 42 to rotate the spindle motor 12 at a desired velocity. It should be noted that the write/read control circuit can judge, based on a prerecorded address, whether data is to be recorded to the land L or groove G. Similarly, the write/read control circuit can judge, based on an address of data to be read, whether the data is recorded on the land L or groove G.

In addition, a comparison circuit may be provided in the matrix circuit to make a comparison in signal level between calculation output signals intended for detection of wobble address information. In this case, address information is obtained by selecting, based on the result of comparison from the comparison circuit, one, from which more address information can be detected, of calculation output signals A+D and B+C, for example, for detection of wobble address information.

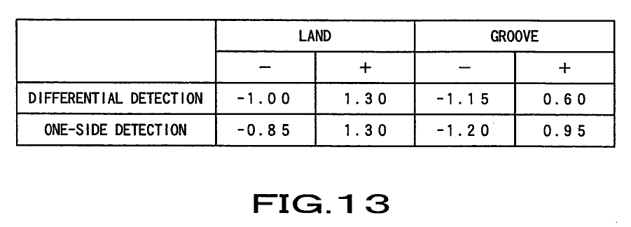

FIG. 13 shows a tilt margin based on the amount of error taking place when address information is reproduced from the wobble signal component. That is, the tilt margin which is an angular range to an angle at which there exits an error correction when detecting a BCH code-based error-corrected address in a so-called MD (Mini Disc, a Sony's trade name), for example, has been verified to be wider in the one-side detection as in the embodiment of the present invention than in the conventional differential detection, as shown in FIG. 13.

In the foregoing, the present invention has been described in detail concerning certain preferred embodiments thereof as examples with reference to the accompanying drawings. However, it should be understood by those ordinarily skilled in the art that the present invention is not limited to the embodiments but can be modified in various manners, constructed alternatively or embodied in various other forms without departing from the scope and spirit thereof as set forth and defined in the appended claims.

1. A reproducing apparatus for reproducing a disk-shaped recording medium in which management data different from to-be-recorded data has been recorded by wobbling one of two side walls of a recording track on which the data is to be recorded, the apparatus comprising:
a driving means for rotating the recording medium at a predetermined velocity;
a light signal irradiating means for irradiating, to the recording medium, a light signal for reading data from the recording medium being rotated by the driving means;
a light detecting means including a photodetector divided in acceptance areas extending along the recording track on the recording medium, each of which detects a part, returned from the recording medium, of the light signal irradiated from the light signal irradiating means; and
a management data reproducing means for reproducing the management data recorded on the side wall of the recording track from a signal output supplied from one of the acceptance areas and derived from the return light detected by the light detecting means.

2. The apparatus according to claim 1, further comprising a signal level comparing means for making a comparison in signal level between signals from the acceptance areas of the light detecting means,
the management data reproducing means selecting, based on the result of comparison from the signal level comparing means, one of the acceptance areas which reproduces the management data recorded on the side wall of the recording track.

3. The apparatus according to claim 1, wherein:
the recording track on the recording medium is formed from a land and groove; and
there is further provided a land/groove setting means for setting which the recording track from which the recorded data is to be read is, a land or groove,
the management data reproducing means selecting, based on the result of setting from the land/groove setting means, one of the acceptance areas which reproduces the management data recorded on the side wall of the recording track.

4. A reproducing method of reproducing management data different from to-be-recorded data by rotating a disk-shaped recording medium in which the management data has been recorded by wobbling one of two side walls of a recording track on which the data is to be recorded, the method comprising the steps of:
irradiating, to the recording medium, a light signal for reading data from the recording medium;
detecting a return light from the recording medium by a light detecting means including a photodetector divided in acceptance areas extending along the recording track on the recording medium, each of which detects a part, returned from the recording medium, of the light signal irradiated in the light signal irradiating step; and
reproducing the management data recorded on the side wall of the recording track from a signal output supplied from one of the acceptance areas and derived from the return light detected by the light detecting means.

5. The method according to claim 4, wherein a comparison is made in signal level between the signals from the acceptance areas of the light detecting means, and one of the acceptance areas which reproduces the management data recorded on the side wall of the recording track is selected based on the result of comparison.

6. The method according to claim 4, wherein:
the recording track on the recording medium is formed from a land and groove; and
one of the acceptance areas which reproduces the management data recorded on the side wall of the recording track is selected based on which the recording track from which the recorded data is to be read is, a land or groove.

7. An optical disk reproducing apparatus for reproducing digital data by rotating an optical disk in which signal information distinguishable from to-be-recorded data has recorded by wobbling one of two side walls of a recording track on which the signal information is to be recorded, irradiating a laser beam to the optical disk and detecting a return light from the latter, wherein:
a light detection signal from one of two acceptance areas formed by bisecting, longitudinally of the recording track, a photodetector that detects a part, returned from the optical disk, of the laser beam irradiated to the latter, is used to detect a signal recorded by wobbling the one side wall of the recording track.

8. The apparatus according to claim 7, wherein there is used a light detection signal from one of the two acceptance areas of the bisected photodetector in which a signal recorded by wobbling one of the side walls of the recording track appears larger.

9. The apparatus according to claim 7, wherein:
the recording track to which the to-be-recorded data is to be recorded is formed from a groove and land on the optical disk, and
either of light detection signals from the two acceptance areas of the photodetector is selectively be used depending upon whether a groove or land is to be traced.

10. The apparatus according to claim 7, wherein any of a light detection signal from one of the two acceptance areas of the photodetector, a light detection signal from the other acceptance area, a sum of the light detection signals from both the acceptance areas and a difference between the light detection signals from both the acceptance areas is selected for use to detect a signal recorded by wobbling one of the side walls of the recording track.
